(19) United States
(12) Patent Application Publication
(10) Pub. No.: US 2014/0055993 A1
(43) Pub. Date: Feb. 27, 2014

(54) LIGHT EMITTING DIODE ILLUMINATING DEVICE HAVING UNIFORM COLOR TEMPERATURE

(71) Applicant: ADVANCED OPTOELECTRONIC TECHNOLOGY, INC., Hsinchu Hsien 303 (TW)

(72) Inventor: MING-TA TSAI, Hsinchu (TW)

(73) Assignee: ADVANCED OPTOELECTRONIC TECHNOLOGY, INC., Hsinchu Hsien 303 (TW)

(21) Appl. No.: 13/948,198

(22) Filed: Jul. 23, 2013

(30) Foreign Application Priority Data
Aug. 21, 2012 (CN) 1012102983889

(51) Int. Cl. F21V 7/00; F21K 99/00

(52) U.S. Cl. CPC F21V 7/00; F21K 9/00
USPC 362/235; 362/249.01

(57) ABSTRACT

An illuminating device comprises a base, a supporting plate formed on the base, a reflective device formed around the supporting plate, and a plurality of lighting elements formed on the supporting plate. The lighting elements include a first lighting module and a second lighting module. Light from the first lighting module has a first color coordinate (x1, y1 wherein x1 is in a range from 0.301 to 0.305; y1 is in a range from 0.296 to 0.301. Light from the second lighting module has a second color coordinate (x2, y2), wherein x2 is in a range from 0.313 to 0.318; y2 is in a range from 0.314 to 0.321. Light from the first lighting module and the second lighting, module are mixed together to emit outside.

### BACKGROUND

1. Technical Field

The present disclosure relates to an illuminating device, and particularly to a light emitting diode (LED) illuminating device having a uniform color temperature.

2. Description of Related Art

LED (light-emitting diode) is a photoelectric semiconductor element which can convert the electric current to light which has a range of specific wavelength. LEDs have advantages such as high brightness, low working; voltage, low power consumption, easy match with integrated circuit, easily to trigger, long life span, and so on. Therefore, as a light source, it is widely applied in illumination area.

The color temperature of the illuminating device must be controlled in a particular range during the process of application. Generally, the manufacturing of above-mentioned illuminating device is carried out by mounting LED light sources with the same color temperature on a horizontal substrate which usually is a printed circuit board. However, even if the LED light sources are produced in the same batch, because of the non-uniform distribution of the phosphor powder and different lengths of paths of light of the LED light sources travelling through the phosphor powder, the color temperature of said illuminating device at different light output parts is not uniform. Usually, the center of the illuminating device has a high color temperature, making the white light thereof become blue white light. The periphery of the illuminating device has a low color temperature, making the white light thereof become a yellow white light. Therefore, the conventional LED illuminating device can not have a uniform color temperature. Moreover, in the conventional art, the LEDs which generate White light with color temperature range higher or lower than the standard color temperature range are regarded as unacceptable, whereby the utilization efficiency of the LEDs are limited.

In view of above-mentioned problem, it is necessary to provide an illuminating device which can generate light with Uniform color temperature, and which can promote the efficiency of use of the LEDs.

### BRIEF DESCRIPTION OF THE DRAWINGS

FIG. 1 is a schematic cross-sectional view of an LED illuminating device in accordance with a first embodiment of the present disclosure.

FIG. 2 is a top view of the distribution device of FIG. 1.

FIG. 3 is a color coordinate distribution graph of different white light LEDs.

FIG. 4 is a schematic cross-sectional view of an LED illuminating device in accordance with a second embodiment of the present disclosure.

### DETAILED DESCRIPTION

Embodiments will now be described in detail below with reference to the appended figures.

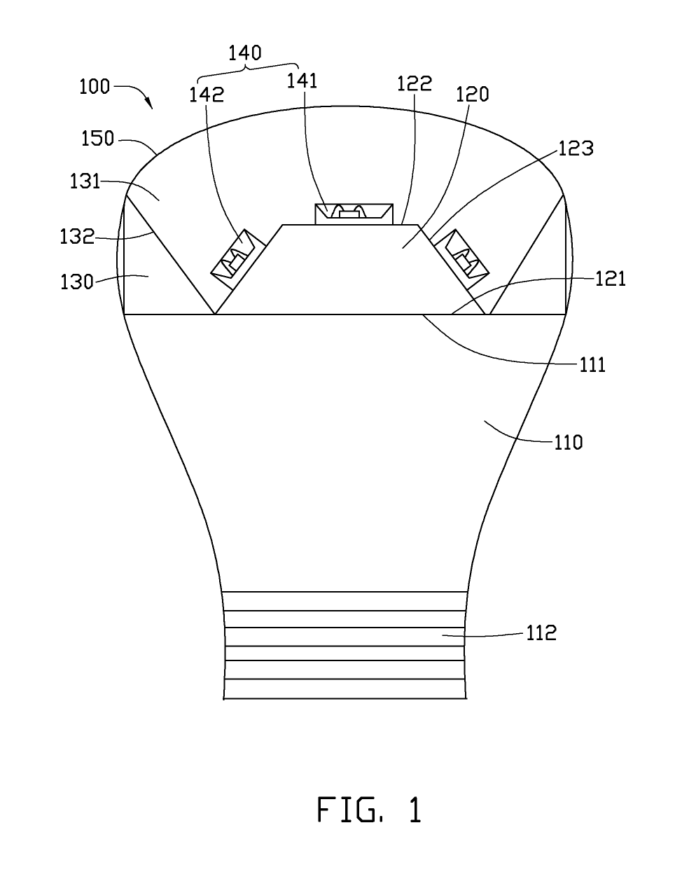

Referring to FIG. 1 an LED illuminating device 100 according to a first embodiment of the present disclosure comprises: a base 110, a supporting plate 120, a reflective device 130 and a plurality of lighting elements 140.

The base 110 has a top surface 111; the supporting plate 120 and the reflective device 130 are disposed on the top surface 111 of the base 110. The part of the base 110 opposite to the top surface 111 has a screw thread interface formed thereon to electrically connect an external power supply.

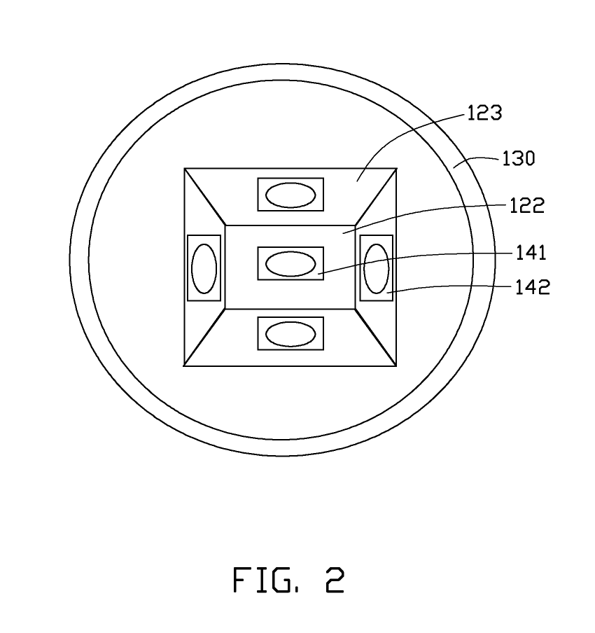

Also referring to FIG. 2, the supporting plate 120 has a bottom surface 121, a top surface 122 and a plurality of side surfaces 123 which connect the bottom surface 121 and the top surface 122. In this embodiment, the supporting plate 120 is as frustum of pyramid. The top surface 122 and the bottom surface 121 are parallel, and the area of top surface 122 is smaller than the area of the bottom surface 121. Relative to the bottom surface 121, the side surfaces 123 are obliquely deposited. If necessary, a conductive circuit which is not shown in the drawings is formed on the top surface 122 and the side surfaces 123 of the supporting plate 120 to provide an electrical connection of the illuminating devices 140 with the screw thread interface 112.

The supporting plate 120 is surrounded by the reflective device 130. In this embodiment, the reflective device 130 has a reflective cavity 131. The supporting plate 120 is deposited in the reflective cavity 131. The opening of the reflective cavity 131 gradually enlarge along the direction of away from the base 110. If necessary, the inner surface of the reflective device 130 can he coated with a reflective layer 132 made of metal.

The lighting element 140 which is disposed on the supporting plate 120 has a first lighting module 141 and a plurality of second lighting modules 142. In this embodiment, the lighting element 140 is a light emitting diode. The first lighting module 141 is mounted on the top surface 122 of the supporting plate 120; the second lighting modules are mounted on the side surfaces 123 of the supporting plate 120, respectively. The color temperature of the light from the second lighting module 142 is higher than the color temperature of the light from the first lighting module 141. The color coordinate of the light from the first lighting module 141 is (x1, y1), wherein x1 is in a range from 0.301 to 0.305, y1 is in a range from 0.296 to 0.301. The color coordinate of the light from the second lighting module 142 is (x2, y2), wherein x2 is in a range from 0.313 to 0.318, y2 is in a range from 0.314 to 0.321. The lights from the first lighting module 141 and the second lighting module 142 are mixed together to emit outside; the color coordinate of the mixed light is (x3, y3), wherein x3 is in a range from 0.305 to 0.313, y3 is in a range from 0.301 to 0.314. In the specification, the color coordinate of the light is a coordinate value of corresponding x and corresponding y of the chromaticity diagram created by the CIE, International Commission on Illumination, in 1931.

The illuminating device 100 further comprises a light cover 150 which overlays the supporting plate 120, the reflective device 130 and lighting element 140. The mixed light from the first lighting module 141 and the second lighting module 142 can emit outside through the light cover 150. If necessary. the outer surface or inner surface of the light cover 150 can be roughened to improve the mixing degree of the mixed light from the first lighting module 141 and the second lighting module 142.

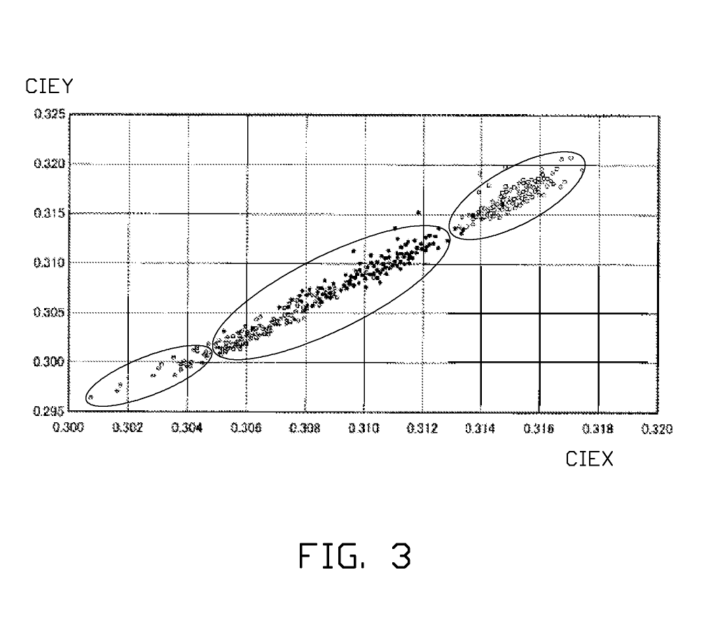

In this embodiment, the light from the first lighting module 141 which has a lower color temperature and the light from the second lighting module 142 which has higher color temperature are mixed together to emit outside. Even though the lights from the first lighting module 141 or the second lighting module 142 both do not match the criteria, however, when the light from the first lighting module 141 mixes with the light from the second lighting module 142, the color temperature of the mixed light is higher than the color temperature of the light from the first lighting module 141 and lower than the color temperature of the light from the second lighting module. Therefore, the color temperature of the light from the whole illuminating device 100 can match the criteria. Referring to FIG. 3, among the LEDs which are produced in the same batch, the color temperature coordinates of some LEDs have a shifting range which is too high or too low from the standard color temperature to make the LEDs not suitable for use in the white light LED illuminating device. Only the LEDs which generate white light having a color temperate which regarding CIEx is in a range from 0.305 to 0.313 and regarding CIEy is in a range from 0.301 to 0.314 can be used to compose the illuminating device. Failing to match the criteria, the LEDs become useless. However, in this embodiment the present disclosure, by combining the LED light source which has the lower color temperature, i.e. CIEx in a range from 0.301 to 0.305, CIEy in a range from 0.296 to 0.301, and the LED light so tree which has the higher color temperature CIEx in a range from 0.313 to 0.318, CIEy in a range from 0.314 to 0.321, to compose a illuminating device, the color temperature coordinates of the light from the illuminating device will be in the standard range i.e. CIEx in a range from 0.305 to 0.313, CIEy in a range from 0.301 to 0.314. In this circumstance, even if the LED light, sources which do not match the criteria, they still can be used in constructing the LED illuminating device; therefore, the utilization efficiency of the LED light sources can be improved.

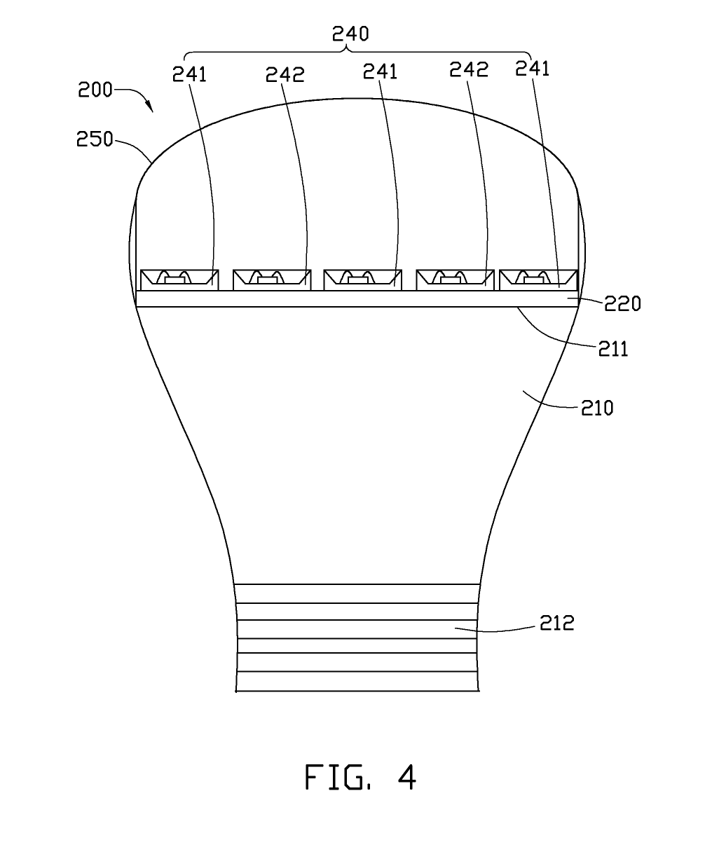

The structures of the illuminating device are not limited to above-mentioned embodiment. Referring to FIG. 4, the illuminating device 200 provided by the second embodiment of the present disclosure; a base 210, a supporting plate 220 and a plurality of lighting elements 240.

The base 210 has a top suffice 211. The supporting plate 220 is deposited on the top surface 211 of the bas 210. The part of the base 210 opposite to the top surface 211 has a screw thread interface 212 formed thereon to electrically connect an external power supply.

The supporting plate 220 is a flat plate; it has a top surface 222 to accommodate a lighting element 240 thereon. If necessary, a conductive circuit (not shown in the drawings) can be provided on the top surface 222 of the supporting plate 220 to provide electrical connection to the lighting element 240.

The lighting element 240 disposed on the supporting plate 220 has a plurality of first lighting modules 241 and a plurality of second lighting modules 242 alternate with the first lighting modules 241. In this embodiment, the lighting element 240 is a light emitting diode. The first lighting modules 241 and the second lighting modules 242 are disposed on the supporting plate 220 with an interval between two adjacent first and second lighting modules 241, 242. The color temperature of the light from the second lighting module 242 is higher than the color temperature of the light from the first lighting module 241. The color coordinate of the light from the first lighting module 241 is (x1, y1), wherein x1 is in a range from 0.301 to 0.305, y1 is in a range from 0.296 to 0.301. The color coordinate of the light from the second lighting module 242 is (x2, y2), wherein x2 is in a range from 0.313 to 0.318, y2 is in a range from 0.314 to 0.321. The mixed light from the first lighting module 241 and the second lighting module 242 emits outside, and the color coordinate of the mixed light is (x3, y3), wherein x3 is in a range from 0.305 to 0.313, y3 is in a range from 0.301 to 0.314.

The illuminating device 200 further comprises a light cover 250 which overlays the supporting plate 220 and the lighting element 240. The mixed light from the first lighting module 241 and the second lighting module 242 emits outside through the light cover 250. If necessary, the outer surface or the inner surface of the light cover 250 can be roughened to improve the mixing degree of the mixed light from the first lighting module 241 and the second lighting module 242.

If necessary, the illuminating device 200 of this embodiment can also comprise a reflective device similar to that mentioned in the first embodiment to reflect the light from the lighting element 240.

The above-mentioned embodiments of the present disclosure are intended to be illustrative only. Numerous alternative embodiments may he devised by persons skilled in the art without departing from the scope of the following claims.

What is claimed is:

1. An illuminating device, comprising:
a base;
a supporting plate formed on the base; and
a plurality of lighting elements formed on the supporting plate, the lighting elements including at least one first lighting module and a plurality of second lighting modules; wherein the light from the at least one first lighting module has a first color coordinate (x1, y1), x1 is in a range from 0.301 to 0.305, y1 is in a range from 0.296 to 0.301, the light from each of the second lighting modules has a second color coordinate (x2, y2), x2 is m a range from 0.313 to 0.318, y2 is in a range from 0.314 to 0.321; the lights from the at least one first lighting module and the second lighting modules are mixed together to emit outside.

2. the illuminating device as claimed in claim 1, where in the supporting plate comprising a bottom surface, a top surface and a plurality of side surfaces which connect the bottom surface and the top surface, the at least one first lighting module is disposed on the top surface of the supporting plate, the second lighting modules arc deposed on the side surfaces of the supporting plate, respectively.

3. The illuminating device, as claimed in claim 2, wherein the bottom surface of the supporting, plate contacts the base, the area of the bottom surface of the supporting plate is larger than the area of the top surface of the supporting.

4. The illuminating device as claimed in claim 3, wherein the supporting plate is a frustum of pyramid.

5. The illuminating device as claimed in claim 2, further comprising a reflective device formed around the supporting plate; wherein a reflective cavity is defined inside of the reflective device, the supporting plate is disposed in the reflective cavity, and the opening of the reflective cavity gradually enlarges along the direction of away from the base.

6. The illuminating device as claimed in claim 5, wherein the light from the second lighting modules is reflected by the reflective device to emit outside.

7. The illuminating device as claimed in claim 1, further comprising a light cover which overlay the supporting plate and the lighting element, the light from the lighting element emitting outside through the light cover.

8. The illuminating device as claimed in claim 1, wherein a part of the base opposite to the supporting plate has a screw thread interface formed thereon, which is configured for electrically connecting with an external power supply.

9. The illuminating device as claimed in claim 1, wherein the supporting plate is a flat plate, the at least one first light module including a plurality of first lighting modules, the first and second lighting modules being alternately disposed on the supporting plate with an interval therebetween.

10. The illuminating device as claimed in claim 1, wherein the mixed light from the at least one first lighting module and the second lighting modules has a third color coordinate (x3, y3), wherein x3 is in a range from 0.305 to 0.313, y3 is in a range from 0.301 to 0.314.
